(19) United States
(12) Patent Application Publication
(10) Pub. No.: US 2026/0323091 A1
(43) Pub. Date: Oct. 15, 2026

(54) ONLINE TRANSFORM KERNEL DERIVATION

(71) Applicant: Tencent America LLC, Palo Alto, CA (US)

(72) Inventors: Yifan WANG, Palo Alto, CA (US); Lien-Fei CHEN, Palo Alto, CA (US); Yonguk YOON, Palo Alto, CA (US); Biao WANG, San Jose, CA (US); Shan LIU, San Jose, CA (US); Ziyue XIANG, Palo Alto, CA (US); Roman CHERNYAK, Santa Clara, CA (US)

(73) Assignee: Tencent America LLC, Palo Alto, CA (US)

(21) Appl. No.: 19/466,229

(22) Filed: Jan. 30, 2026

Related U.S. Application Data
(60) Provisional application No. 63/753,341, filed on Feb. 3, 2025.

(51) Int. Cl. H04N 19/61; H04N 19/159; H04N 19/176; H04N 19/196

(52) U.S. Cl. CPC H04N 19/61; H04N 19/159; H04N 19/176; H04N 19/196

(57) ABSTRACT

Some aspects of the disclosure provide a method of video decoding. For example, bitstream is received. The bitstream includes coded information of a sequence of pictures in a video. Training data for an online transform kernel derivation for a current block is collected based on one or more reconstructed blocks in the sequence of pictures. A transform kernel for the current block is derived based on the training data. The current block is reconstructed based on the transform kernel.

### INCORPORATION BY REFERENCE

The present application claims the benefit of priority to U.S. Provisional Application No. 63/753,341, filed on Feb. 3, 2025. The entire disclosure of the prior application is hereby incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. For example, bitstream is received. The bitstream includes coded information of a sequence of pictures in a video. Training data for an online transform kernel derivation for a current block is collected based on one or more reconstructed blocks in the sequence of pictures. A transform kernel for the current block is derived based on the training data. The current block is reconstructed based on the transform kernel.

Some aspects of the disclosure provide a method for video encoding. In an example, to apply an online transform kernel derivation for a current block of a current picture in a sequence of pictures in a video is determined. Training data for the online transform kernel derivation for the current block is collected based on one or more reconstructed blocks in the sequence of pictures. A transform kernel for the current block is derived based on the training data. The current block is encoded into coded information in a bitstream based on the transform kernel.

Aspects of the disclosure also provide an apparatus for video decoding. The apparatus for video encoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows a flow chart outlining a decoding process according to some aspects of the disclosure.

FIG. 5 shows a flow chart outlining an encoding process according to some aspects of the disclosure.

FIG. 6 is a schematic illustration of a computer system in accordance with an aspect.

### DETAILED DESCRIPTION

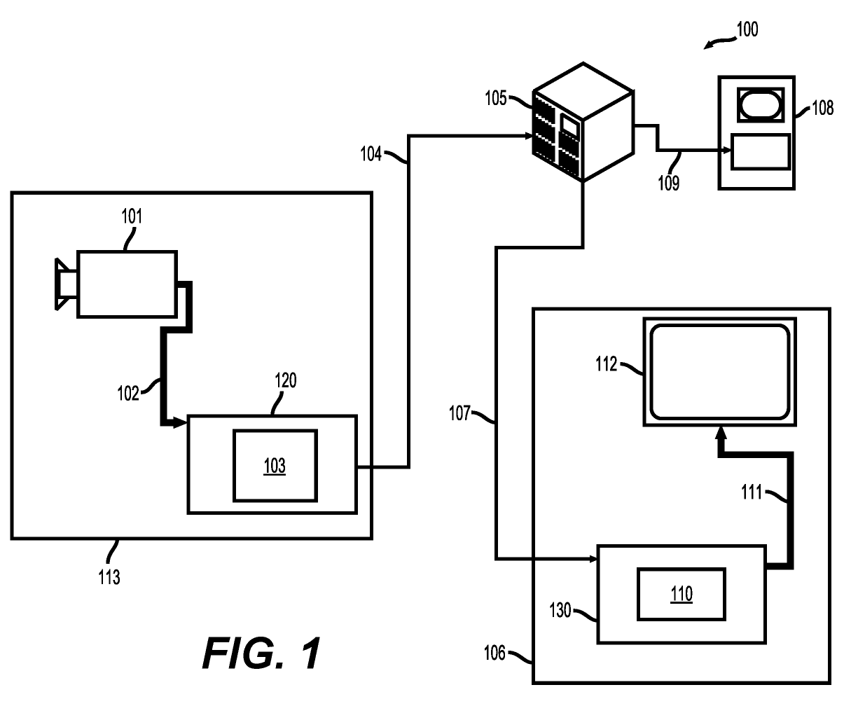

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

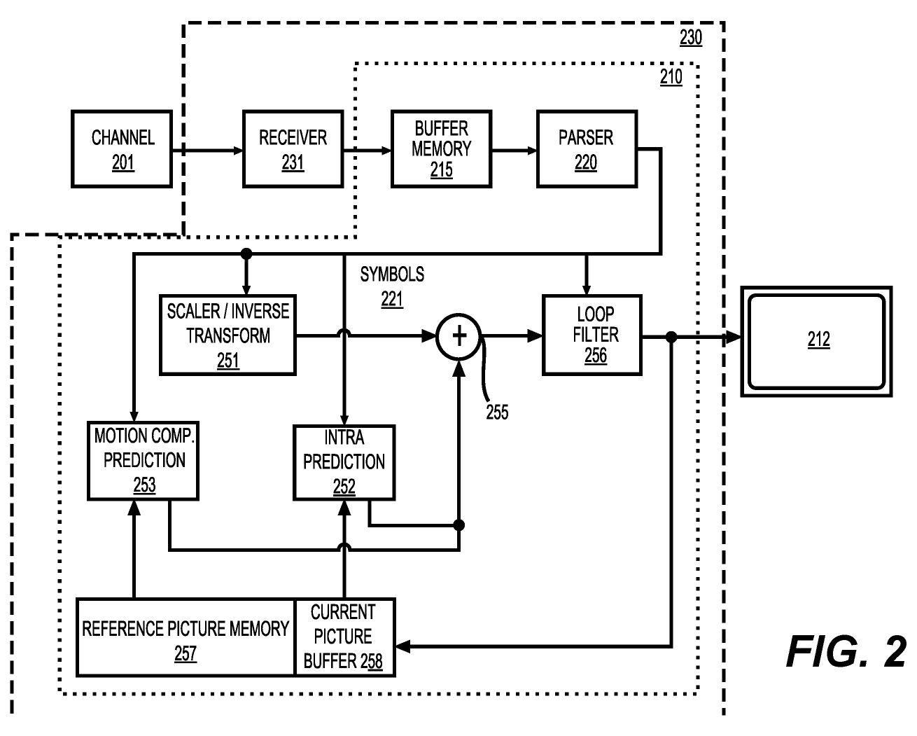

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder / parser (220) ("parser (220)" henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse / entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding / parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler / inverse transform unit (251). The scaler / inverse transform unit (251) receives a quantized transform coefficient as well as control information, including which transform to use, block size, quantization factor, quantization scaling matrices, etc. as symbol(s) (221) from the parser (220). The scaler / inverse transform unit (251) can output blocks comprising sample values, that can be input into aggregator (255).

In some cases, the output samples of the scaler / inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler / inverse transform unit (251).

In other cases, the output samples of the scaler / inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler / inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

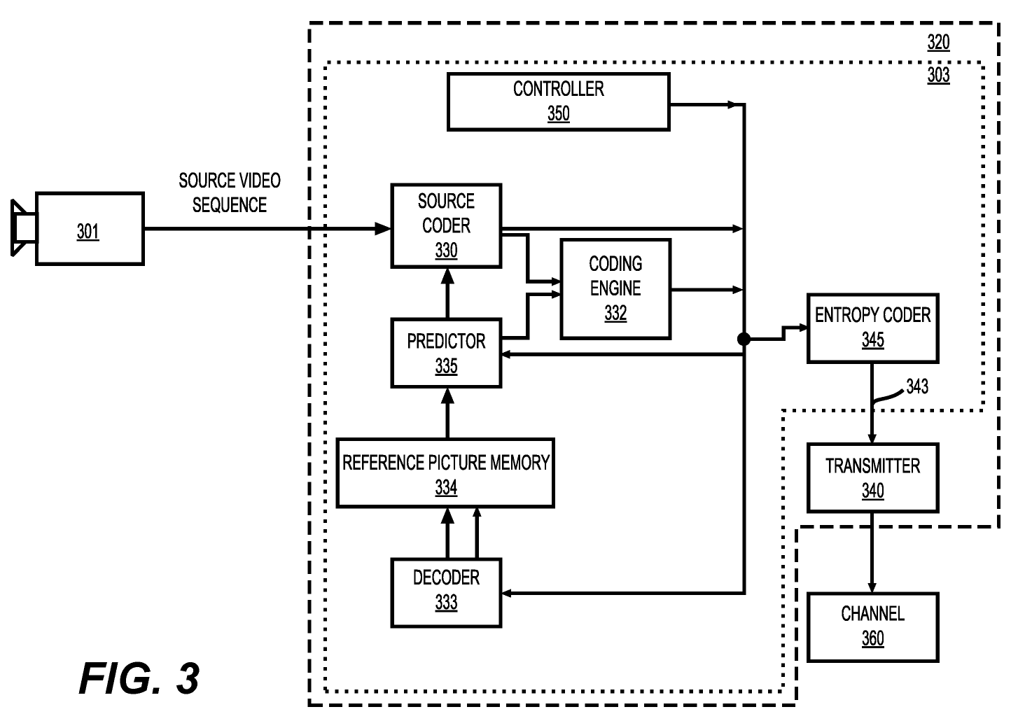

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, …), any colorspace (for example, BT.601 Y CrCB, RGB, …), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, …), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder "sees" as reference picture samples exactly the same sample values as a decoder would "see" when using prediction during decoding. This fundamental principle of reference picture synchronicity (and resulting drift, if synchronicity cannot be maintained, for example because of channel errors) is used in some related arts as well.

The operation of the "local" decoder (333) can be the same as a "remote" decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as "reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4x4, 8x8, 4x8, or 16x16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64x64 pixels, 32x32 pixels, or 16x16 pixels. In general, a CTU includes three coding tree blocks (CTBs), which are one luma CTB and two chroma CTBs. Each CTU can be recursively quadtree split into one or multiple coding units (CUs). For example, a CTU of 64x64 pixels can be split into one CU of 64x64 pixels, or 4 CUs of 32x32 pixels, or 16 CUs of 16x16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8x8 pixels, 16x16 pixels, 8x16 pixels, 16x8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques for online transform kernel derivation.

According to some aspects, image and video coding standards can use a hybrid video coding framework. A hybrid video coding framework can include various modules, such as intra prediction, inter prediction, transform, quantization and in-loop filter.

In video codec, techniques, such as transform, quantization, and the like are used to reduce redundancy and improve coding efficiency in video signals. For example, transform techniques can reduce redundancy in the video signal by decorrelation, and quantization techniques can decrease the data of the transform coefficient representation by reducing precision, for example by removing imperceptible details, and thus reducing irrelevance in the data.

In some examples, transformation decorrelates a signal by transforming the signal from the spatial domain to a transform domain (e.g., a frequency domain), using a suitable transform basis. For example, a transform is applied to the prediction residual (regardless of whether it comes from inter- or intra-picture prediction), that is, the difference between the prediction and the original input video signal. In the transform domain, the essential information typically concentrates into a small number of coefficients. Transform is also referred to as energy compaction that can compact visual information into a small number of coefficients. At the decoder, the inverse transform can be applied to reconstruct the residual samples.

Generally, quantization is used to reduce the precision of an input value or a set of input values in order to decrease the amount of data needed to represent the values. In some examples, the quantization is typically applied to individual transformed residual samples (e.g., transform coefficients), resulting in integer coefficient levels. The quantization process is applied at the encoder. At the decoder, the corresponding process is known as inverse quantization (also referred to as dequantization), which restores the original value range without regaining the precision.

In some codec examples (e.g., VVC), multiple transform types, such as type-2 DCT (DCT-2), type-7 DST (DST-7), type-8 DCT (DCT-8), and the like can be used in the primary transform. In some examples, techniques that are referred to as multiple transform selection (MTS) can be used. In an example, an explicit MTS can use a signal to explicitly indicate a selection of a transform kernel. In another example, an implicit MTS can implicitly derive a selection of a transform kernel. In some aspects, the explicit MTS can be applied to both intra and inter coded blocks, while the implicit MTS can be used only for intra coded blocks. In an aspect, in the explicit MTS, the choice of DST-7/DCT-8 is indicated by explicit signaling of the transform type. In another aspect, in implicit MTS, the transform type is selected based on coded information that is known to both the encoder and decoder, and transform type signaling is not needed.

In some examples, in the explicit MTS, the index (e.g., denoted by mts_idx) is signaled at the end of CU level syntax to indicate the transform type for horizontal transform and vertical transform. In an example, the value of mts_idx ranges from 0 to 4. For example, value 0 of mts_idx indicates a use of DCT-2 for horizontal transform and vertical transform; value 1 of mts_idx indicates a use of DST-7 for horizontal transform and vertical transform; value 2 of mts_idx indicates a use of DCT-8 for horizontal transform and DST-7 for vertical transform; value 3 of mts_idx indicates a use of DST-7 for horizontal transform and DCT-8 for vertical transform; and value 4 of mts_idx indicates a use of DCT-8 for horizontal transform and vertical transform.

In some examples, secondary transform is a kind of non-primary transform, and can be applied following the primary transform. For example, low-frequency non-separable transform (LFNST) is a non-separable transform that can be applied to the top-left low-frequency region of primary transform coefficients. In some examples (e.g., VVC), the LFNST can be applied for intra coded blocks that use DCT-2 as the primary transform. The transform kernels defined in LFNST can include multiple transform sets, such as 4 transform sets in VVC. In some examples, a selection of a transform set from the four LFNST sets (e.g., denoted by lfnstSetIdx), depends on the intra prediction mode (e.g., denoted by intraPredMode). In some examples, a lookup table is used, and the lookup table maps LFNST sets to intra prediction modes. In some examples, an index can be signaled to select a kernel in an LFNST set (e.g., the LFNST set that maps to an intra prediction mode).

In some aspects, different types of DCT are available as candidates, and a suitable DCT can be selected to improve coding efficiency. In some examples, non-separable primary transform (NSPT) and low-frequency non-separable transform (LFNST) provide learned kernels to maximize the energy compaction ability. At the decoder side, the linear (inverse) transform kernel is applied on the de-quantized coefficient to reconstruct the spatial blocks.

In some aspects, transforms, such as DCT, DST and the like, are used to compact the energy. In some examples, trained transform kernels (e.g., primary transform kernels, non-primary transform kernels) are adopted for better energy compaction. The trained transform kernels are derived through training based on collected training data.

Some aspects of the disclosure provide online training techniques for transform kernel derivation. For example, based on current block characteristic and information available, an online trained transform kernel can be derived at the encoding/decoding stage to provide better coding efficiency for current block’s residual.

In some examples, at an encoder side, the encoder can obtain encoder side training data for training a transform kernel of a block in a video sequence from reconstructed portion of the video sequence, and derive the transform kernel for the block based on the encoder side training data that is obtained from the video sequence. At the decoder side, the decoder can obtain decoder side training data for training a transform kernel of a block in a video sequence from reconstructed portion of the video sequence, and derive the transform kernel of the block based on the decoder side training data. It is noted that suitable techniques can be used to make sure that the encoder side training data matches with the decoder side training data. Thus, a transform kernel of a block derived at the encoder side is the same as a transform kernel of the block derived at the decoder side.

It is noted that various techniques can be used to perform the training. In some examples, an algorithm, such as Karhunen–Loève transform (KLT) can be performed to derive the online trained transform kernel according to the training data. In some examples, a model of transform kernel with variables is predefined, and the variable values can be derived based on the training data. In some examples, multiple transform kernel candidates can be obtained, and one of the transform kernel candidates can be selected based on the training data. In some examples, an initial transform kernel is suitably obtained, and the initial transform kernel can be updated based on the training data. In some examples, a neural network is used to derive the transform kernel based on the training data.

In some aspects, for blocks with the reference blocks ready. The online training data for the transform kernel can be derived from these reference blocks at decoder/encoder side. In an aspect, a block is coded by a prediction mode that generates a prediction block of the block based on a reference block that is selected from one or more candidate reference blocks. The one or more candidate reference blocks can be used as the online training data to derive the transform kernel of the block.

In some examples, for intra modes, such as intra template matching prediction (IntraTMP) where one or more block vectors are available, the reconstructed residuals of the reference blocks can be used as training data.

In an aspect, intra template matching prediction (IntraTMP) is a screen/content-oriented intra coding tool that predicts a block by copying similar content from elsewhere in the same picture, guided by matching a template. For example, the template is formed by a set of already decoded boundary samples around the current block. The encoder searches candidate positions within the same picture for blocks whose boundary around the candidate position best matches the template of the current block under a distortion metric (e.g., SAD/SSD over the template samples). The best match yields a displacement vector. The predicted block is the content at that location with the displacement vector, and can be copied into the current block position. A residual can be computed and coded in the usual transform/quantization pipeline.

In an example, for a current block coded in IntraTMP mode, candidate reference blocks can be selected based on the respective boundary of the candidate reference blocks. For example, when a boundary distortion metric of a candidate reference block satisfies a condition (e.g., smaller than a threshold), the candidate reference block can be selected. In an example, the reconstructed residuals of the selected candidate reference blocks can be used in the online training to derive the transform kernel for the current block. In another example, reconstructed residuals of the selected candidate reference blocks and the transform kernels of the selected candidate reference blocs that are used to reconstruct the candidate reference blocks can be used in the online training to derive the transform kernel for the current block.

In some examples, for inter blocks with several reference motion vectors, the reconstructed residuals of the reference blocks can be used as training data. In an example, for a current block coded in an inter prediction mode, candidate reference blocks can be determined based on reference picture list and reference motion vectors. The candidate reference blocks can be used to obtain training data for the online training to derive the transform kernel for the current block. In an example, the reconstructed residuals of the candidate reference blocks can be used as training data in the online training to derive the transform kernel for the current block. In another example, the reconstructed residuals of the candidate reference blocks and the respective transform kernels that are used to reconstruct the candidate reference blocks can be used as training data in the online training to derive the transform kernel for the current block.

In some aspects, for blocks without any reference, (pseudo) reference blocks can be found based on the current block and suitable available information, the (pseudo) reference blocks can be used to obtain training data for online transform kernel derivation.

In some examples, a template matching process can be performed to find the (pseudo) reference blocks, and the (pseudo) reference blocks can be used to obtain training data for the online training to derive the transform kernel for the current block. In an example, the reconstructed residuals of the (pseudo) reference blocks can be used as training data for online transform kernel derivation. In another example, the reconstructed residuals of the (pseudo) reference blocks and the transform kernels of the (pseudo) reference blocks can be used as training data for online transform kernel derivation.

In some examples, the (reconstructed) blocks with the same flag(s)/information as current block can be used as (pseudo) reference blocks. In an example, the (reconstructed) blocks with the same intra prediction mode (e.g., in the same picture or different pictures) can be used as a criterion to collect data (pseudo reference blocks) for the online transform kernel derivation. In an example, for i-frame, the reconstructed blocks with the same intra prediction mode are in the i-frame as the current block. In another example, for a b-frame, the reconstructed blocks with the same intra prediction mode can be in reference frames of the current frame. The current block’s transform kernel can be updated/retrained according to reconstructed residuals of the previously decoded blocks (e.g., reconstructed residuals of the pseudo reference blocks).

In some examples, the neighbor blocks of the current block can be used as (pseudo) reference blocks to derive the online trained transform kernel for current block’s residual. In an example, for the current block, reconstructed residuals from the neighbor blocks can be collected (overlapped/non-overlapped) as the training data to derive the online trained transform kernel. In some examples, the neighbor blocks can be overlapped. In some examples, the neighbor blocks are non-overlapped.

In some aspects, the online-trained transform kernel for the current block can be derived by using the data through filtering the reconstructed reference blocks. In some examples, a high pass filter can be applied on the reconstructed reference blocks to derive pseudo-residuals that are used as the training data for current block’s transform kernel.

In some aspects, any suitable kernel derivation methods can be used to derive the online-trained transform kernel.

In some examples, Karhunen–Loève transform (KLT) can be performed according to the training data to derive the online trained transform kernel.

In some examples, methods with a cost function guidance can be used to derive the transform kernel. In some examples, cost values associated with candidate transform kernels can be calculated according to a cost function. A candidate transform kernel can be selected based on the cost values to obtain the derived transform kernel. In an example, the cost function is calculated based on prediction errors. In another example, the cost function is calculated based on energy compaction (e.g., least number of bits for coding coefficients).

In some examples, the online trained transform kernel can be tuned by starting from an existing transform kernel using the data collected (e.g., the training data from the reference blocks). In an example, an initial transform kernel is suitably determined, and the initial transform kernel is tuned according to the training data.

In some examples, approaches that select the transform kernel from existing transform candidates based on the data/information collected can be used. In an example, a transform kernel histogram can be built from the reference blocks and used to derive the transform type for current block. In an example, the transform kernels of the reference blocks can be used to build a transform kernel histogram, and the transform kernel of the current block is selected according to the transform kernel histogram, such as the one with the highest occurrence.

In some aspects, the online trained transform kernel can be enabled based a flag signaled in TU/CU/slice/tile/picture etc level.

In some aspects, the usage of online trained transform kernel can be inferred from the information available.

In some examples, online transform kernel derivation can be enabled when the number of training blocks is larger than certain threshold. For example, the online transform kernel derivation is enabled when the number of candidate reference blocks is larger than a predefined threshold.

In some examples, online transform kernel derivation can be enabled when the reference blocks are correlated enough to the current block. In an example, a correlation of a candidate reference block to the current block is calculated according to the reconstructed candidate reference block and a prediction block of the current block. In another example, a correlation of a candidate reference block to the current block is calculated according to a prediction block of the candidate reference block and a prediction block of the current block.

In some examples, the transform kernel that is derived according to the online transform kernel derivation can be enabled when the transform kernel performs good on current block’s template. In an example, after the transform kernel is derived according to the online transform kernel derivation, the transform kernel is applied on a template of the current block. When the performance of the transform kernel on the template of the current block satisfies a requirement, then the transform kernel is enabled to be applied to the current block. In an example, a rate-distortion (RD) is calculated when the transform kernel is applied on the template of the current block. When the RD of the transform kernel on the template satisfies a requirement, the transform kernel is enabled and can be performed on the current block. In another example, energy compaction of the transform kernel is measured when the transform kernel is applied on the template of the current block. When the energy compaction of the transform kernel on the template satisfies a requirement, the transform kernel is enabled and can be performed on the current block.

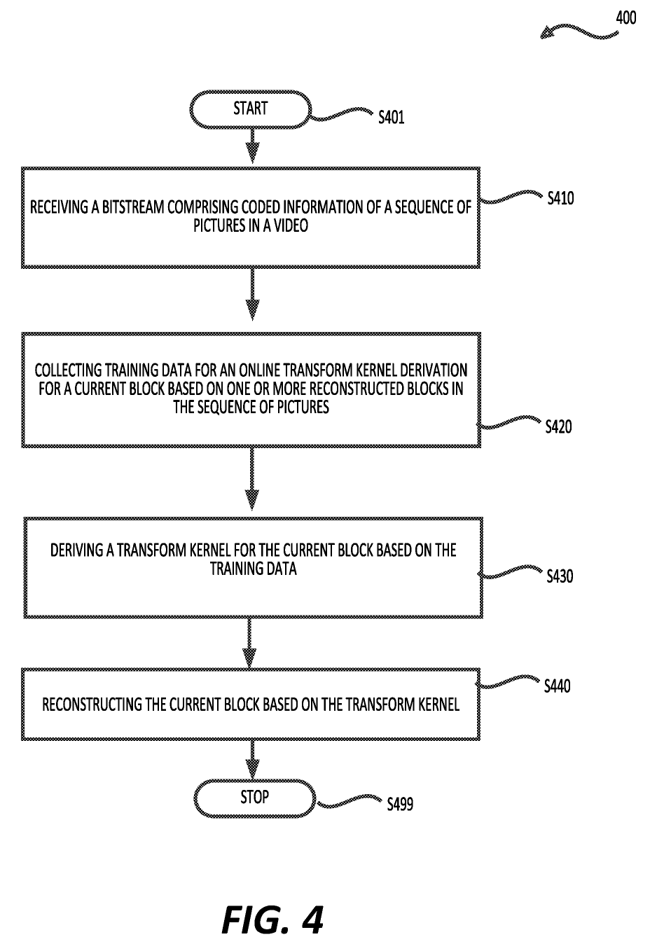

FIG. 4 shows a flow chart outlining a process (400) according to an aspect of the disclosure. The process (400) can be used in a video decoder. In various aspects, the process (400) is executed by processing circuitry, such as the processing circuitry that performs functions of the video decoder (110), the processing circuitry that performs functions of the video decoder (210), and the like. In some aspects, the process (400) is implemented in software instructions, thus when the processing circuitry executes the software instructions, the processing circuitry performs the process (400). The process starts at (S401) and proceeds to (S410).

At (S410), a bitstream is received. The bitstream includes coded information of a sequence of pictures in a video.

At (S420), training data for an online transform kernel derivation for a current block is collected based on one or more reconstructed blocks in the sequence of pictures.

At (S430), a transform kernel for the current block is derived based on the training data.

At (S440), the current block is reconstructed based on the transform kernel. For example, inverse transform is applied to transform coefficients that are decoded from the bitstream to generate a residual block for the current block, and the residual block is combined with a prediction block to generate a reconstructed block for the current block.

In some aspects, the current block is predicted based on one or more reference blocks that are selected from a plurality of candidate reference blocks. The training data is collected based on reconstructed residuals of the plurality of candidate reference blocks.

In an example, the current block is in an intra prediction mode, and the plurality of candidate reference blocks are in a same picture as the current block, the plurality of candidate reference blocks are associated with respective block vectors that are available for the intra prediction mode.

In another example, the current block is in an inter prediction mode, and the plurality of candidate reference blocks are in respective reference pictures of the current block, the plurality of candidate reference blocks are associated with respective motion vectors and respective reference pictures.

In an aspect, a template matching process that determines one or more matching blocks of the current block is performed, a template of a matching block in the one or more matching blocks satisfies a matching condition to a template of the current block. The training data is collected according to the one or more matching blocks.

In another aspect, the one or more reconstructed blocks that have at least a same flag as the current block are collected to be the training data.

In another aspect, the one or more reconstructed blocks that have a same intra prediction mode as the current block are collected to be the training data.

In another aspect, the one or more reconstructed blocks that are neighboring blocks of the current block are collected to be the training data.

In some examples, the one or more reconstructed blocks are filtered using a high pass filter to obtain pseudo-residuals of the one or more reconstructed blocks. The training data is collected according to the pseudo-residuals.

In an example, the transform kernel for the current block is derived using Karhunen-Loève transform (KLT).

In another example, the transform kernel for the current block is derived according to cost values associated with the training data by using a cost function.

In another example, parameters of an initial transform kernel are tuned according to the training data to derive the transform kernel.

In another example, the transform kernel is selected from a plurality of transform kernel candidates according to the training data.

In some examples, the transform kernel is selected according to a transform kernel histogram that is built from the training data.

In some examples, a flag is decoded from the bitstream, the flag indicates whether the online transform kernel derivation is enabled. the flag is signaled in at least one of a transform unit level, a coding unit level, a slice level, a tile level, and a picture level.

In an aspect, the online transform kernel derivation is inferred to be enabled when a counting number of the one or more reconstructed blocks that are available in the training data is larger than a threshold.

In an aspect, the online transform kernel derivation is inferred to be enabled when correlations of the one or more reconstructed blocks to the current block are higher than a predefined level.

In an aspect, the online transform kernel derivation is inferred to be enabled when a performance metric of the transform kernel on a template of the current block satisfies a requirement.

Then, the process proceeds to (S499) and terminates.

The process (400) can be suitably adapted. Step(s) in the process (400) can be modified and/or omitted. Additional step(s) can be added. Any suitable order of implementation can be used.

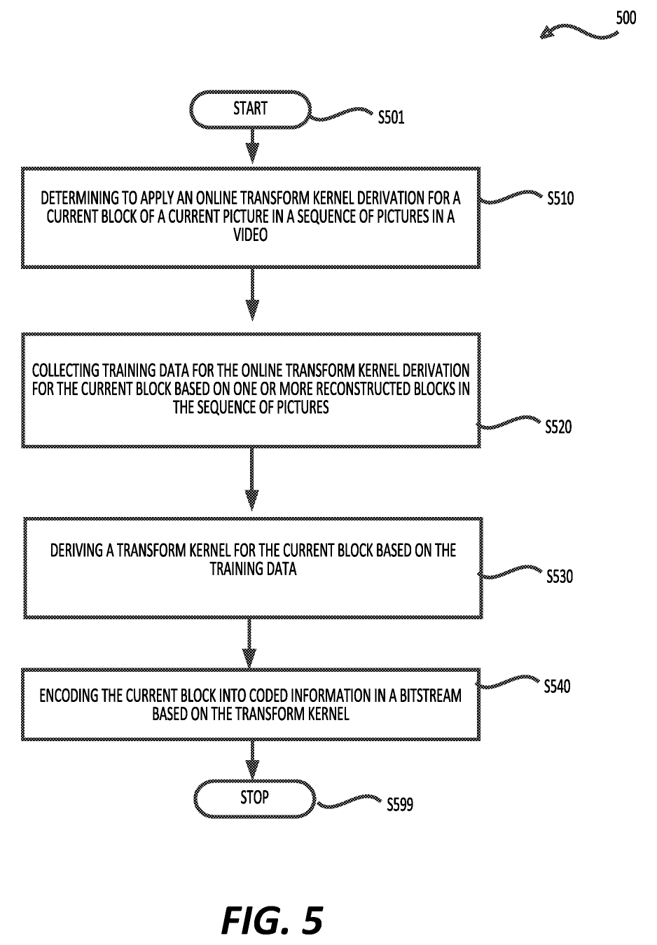

FIG. 5 shows a flow chart outlining a process (500) according to an aspect of the disclosure. The process (500) can be used in a video encoder. In various aspects, the process (500) is executed by processing circuitry, such as the processing circuitry that performs functions of the video encoder (103), the processing circuitry that performs functions of the video encoder (303), and the like. In some aspects, the process (500) is implemented in software instructions, thus when the processing circuitry executes the software instructions, the processing circuitry performs the process (500). The process starts at (S501) and proceeds to (S510).

At (S510), to apply an online transform kernel derivation for a current block of a current picture in a sequence of pictures in a video is determined.

At (S520), training data for the online transform kernel derivation for the current block is collected based on one or more reconstructed blocks in the sequence of pictures.

At (S530), a transform kernel for the current block is derived based on the training data.

At (S540), the current block is encoded into coded information in a bitstream based on the transform kernel. In an example, a prediction block of the current block is generated. A residual block is calculated according to the prediction block and the current block. The transform kernel is applied on the residual block to obtain transform coefficients. The transform coefficients are suitably encoded into the coded information in the bitstream.

In an aspect, the current block is predicted based on one or more reference blocks that are selected from a plurality of candidate reference blocks. The training data is collected based on reconstructed residuals of the plurality of candidate reference blocks.

In some examples, the current block is in an intra prediction mode, and the plurality of candidate reference blocks are in a same picture as the current block, the plurality of candidate reference blocks are associated with respective block vectors that are available for the intra prediction mode.

In some examples, the current block is in an inter prediction mode, and the plurality of candidate reference blocks are in respective reference pictures of the current block, the plurality of candidate reference blocks are associated with respective motion vectors and respective reference pictures.

In some examples, a template matching process that determines one or more matching blocks of the current block is performed, a template of a matching block in the one or more matching blocks satisfying a matching condition to a template of the current block. The training data is collected according to the one or more matching blocks.

In another aspect, the one or more reconstructed blocks that have at least a same flag as the current block are collected to be the training data.

In another aspect, the one or more reconstructed blocks that have a same intra prediction mode as the current block are collected to be the training data.

In another aspect, the one or more reconstructed blocks that are neighboring blocks of the current block are collected to be the training data.

In some examples, the one or more reconstructed blocks are filtered using a high pass filter to obtain pseudo-residuals of the one or more reconstructed blocks. The training data is collected according to the pseudo-residuals.

In an example, the transform kernel for the current block is derived using Karhunen-Loève transform (KLT).

In another example, the transform kernel for the current block is derived according to cost values associated with the training data by using a cost function.

In another example, parameters of an initial transform kernel are tuned according to the training data to derive the transform kernel.

In another example, the transform kernel is selected from a plurality of transform kernel candidates according to the training data.

In some examples, the transform kernel is selected according to a transform kernel histogram that is built from the training data.

In an aspect, the online transform kernel derivation is inferred to be enabled when a counting number of the one or more reconstructed blocks that are available in the training data is larger than a threshold.

In an aspect, the online transform kernel derivation is inferred to be enabled when correlations of the one or more reconstructed blocks to the current block are higher than a predefined level.

In an aspect, the online transform kernel derivation is inferred to be enabled when a performance metric of the transform kernel on a template of the current block satisfies a requirement.

In some examples, a flag is encoded into the bitstream, the flag indicates whether the online transform kernel derivation is enabled, the flag can be signaled in at least one of a transform unit level, a coding unit level, a slice level, a tile level, and a picture level.

Then, the process proceeds to (S599) and terminates.

The process (500) can be suitably adapted. Step(s) in the process (500) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

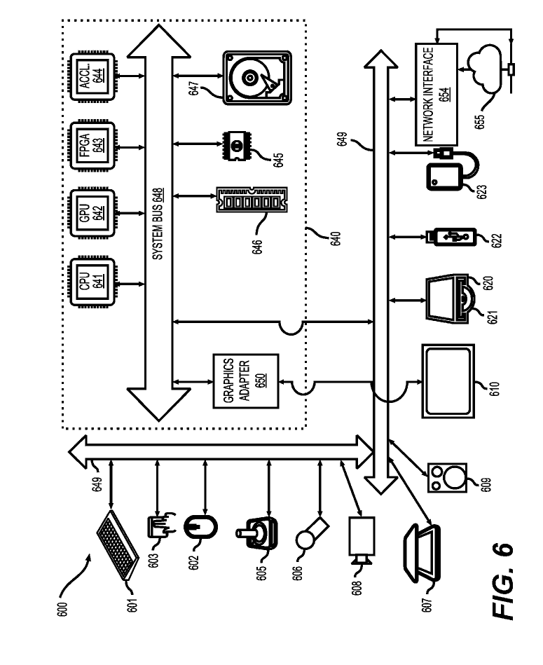

The techniques described above, can be implemented as computer software using computer-readable instructions and physically stored in one or more computer-readable media. For example, FIG. 6 shows a computer system (600) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 6 for computer system (600) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (600).

Computer system (600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (601), mouse (602), trackpad (603), touch screen (610), data-glove (not shown), joystick (605), microphone (606), scanner (607), camera (608).

Computer system (600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (610), data-glove (not shown), or joystick (605), but there can also be tactile feedback devices that do not serve as input devices), audio output devices (such as: speakers (609), headphones (not depicted)), visual output devices (such as screens (610) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (600) can also include human accessible storage devices and their associated media such as optical media including CD/DVD ROM/RW (620) with CD/DVD or the like media (621), thumb-drive (622), removable hard drive or solid state drive (623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (600) can also include an interface (654) to one or more communication networks (655). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (649) (such as, for example USB ports of the computer system (600)); others are commonly integrated into the core of the computer system (600) by attachment to a system bus as described below (for example Ethernet interface into a PC computer system or cellular network interface into a smartphone computer system). Using any of these networks, computer system (600) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (640) of the computer system (600).

The core (640) can include one or more Central Processing Units (CPU) (641), Graphics Processing Units (GPU) (642), specialized programmable processing units in the form of Field Programmable Gate Areas (FPGA) (643), hardware accelerators for certain tasks (644), graphics adapters (650), and so forth. These devices, along with Read-only memory (ROM) (645), Random-access memory (646), internal mass storage such as internal non-user accessible hard drives, SSDs, and the like (647), may be connected through a system bus (648). In some computer systems, the system bus (648) can be accessible in the form of one or more physical plugs to enable extensions by additional CPUs, GPU, and the like. The peripheral devices can be attached either directly to the core’s system bus (648), or through a peripheral bus (649). In an example, the screen (610) can be connected to the graphics adapter (650). Architectures for a peripheral bus include PCI, USB, and the like.

CPUs (641), GPUs (642), FPGAs (643), and accelerators (644) can execute certain instructions that, in combination, can make up the aforementioned computer code. That computer code can be stored in ROM (645) or RAM (646). Transitional data can also be stored in RAM (646), whereas permanent data can be stored for example, in the internal mass storage (647). Fast storage and retrieve to any of the memory devices can be enabled through the use of cache memory, that can be closely associated with one or more CPU (641), GPU (642), mass storage (647), ROM (645), RAM (646), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (600), and specifically the core (640) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (640) that are of non-transitory nature, such as core-internal mass storage (647) or ROM (645). The software implementing various aspects of the present disclosure can be stored in such devices and executed by core (640). A computer-readable medium can include one or more memory devices or chips, according to particular needs. The software can cause the core (640) and specifically the processors therein (including CPU, GPU, FPGA, and the like) to execute particular processes or particular parts of particular processes described herein, including defining data structures stored in RAM (646) and modifying such data structures according to the processes defined by the software. In addition or as an alternative, the computer system can provide functionality as a result of logic hardwired or otherwise embodied in a circuit (for example: accelerator (644)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features can be combined in various manners and are not limited to the combinations noted below. (1).
A method of video decoding, including: receiving a bitstream including coded information of a sequence of pictures in a video; collecting training data for an online transform kernel derivation for a current block based on one or more reconstructed blocks in the sequence of pictures; deriving a transform kernel for the current block based on the training data; and reconstructing the current block based on the transform kernel.
(2). The method of feature (1), in which the current block is predicted based on one or more reference blocks that are selected from a plurality of candidate reference blocks, and the collecting includes: collecting the training data based on reconstructed residuals of the plurality of candidate reference blocks.
(3). The method of any of features (1) to (2), in which the current block is in an intra prediction mode, and the plurality of candidate reference blocks are in a same picture as the current block, the plurality of candidate reference blocks are associated with respective block vectors that are available for the intra prediction mode.
(4). The method of any of features (1) to (3), in which the current block is in an inter prediction mode, and the plurality of candidate reference blocks are in respective reference pictures of the current block, the plurality of candidate reference blocks are associated with respective motion vectors and respective reference pictures.
(5). The method of any of features (1) to (4), in which the collecting includes: performing a template matching process that determines one or more matching blocks of the current block, a template of a matching block in the one or more matching blocks satisfying a matching condition to a template of the current block; and collecting the training data according to the one or more matching blocks.
(6). The method of any of features (1) to (5), in which the collecting includes: selecting the one or more reconstructed blocks that have at least a same flag as the current block.
(7). The method of any of features (1) to (6), in which the selecting includes: selecting the one or more reconstructed blocks that have a same intra prediction mode as the current block.
(8). The method of any of features (1) to (7), in which the collecting includes: selecting the one or more reconstructed blocks that are neighboring blocks of the current block.
(9). The method of any of features (1) to (8), in which the collecting includes: filtering the one or more reconstructed blocks using a high pass filter to obtain pseudo-residuals of the one or more reconstructed blocks; and collecting the training data according to the pseudo-residuals.
(10). The method of any of features (1) to (9), in which the deriving includes: deriving the transform kernel for the current block using Karhunen Loève transform (KLT).
(11). The method of any of features (1) to (10), in which the deriving includes: deriving the transform kernel for the current block according to cost values associated with the training data by using a cost function.
(12). The method of any of features (1) to (11), in which the deriving includes: tuning parameters of an initial transform kernel according to the training data to obtain the transform kernel.
(13). The method of any of features (1) to (12), in which the deriving includes: selecting the transform kernel from a plurality of transform kernel candidates according to the training data.
(14). The method of any of features (1) to (13), in which the selecting includes: selecting the transform kernel according to a transform kernel histogram that is built from the training data.
(15). The method of any of features (1) to (14), further including: decoding a flag from the bitstream, the flag indicating whether the online transform kernel derivation is enabled, the flag being signaled in at least one of a transform unit level, a coding unit level, a slice level, a tile level, and a picture level.
(16). The method of any of features (1) to (15), further including: inferring that the online transform kernel derivation is enabled when a counting number of the one or more reconstructed blocks that are available in the training data is larger than a threshold.
(17). The method of any of features (1) to (16), further including: inferring that the online transform kernel derivation is enabled when correlations of the one or more reconstructed blocks to the current block are higher than a predefined level.
(18). The method of any of features (1) to (17), further including: inferring that the online transform kernel derivation is enabled when a performance metric of the transform kernel on a template of the current block satisfies a requirement.
(19). A method of video encoding, including: determining to apply an online transform kernel derivation for a current block of a current picture in a sequence of pictures in a video; collecting training data for the online transform kernel derivation for the current block based on one or more reconstructed blocks in the sequence of pictures; deriving a transform kernel for the current block based on the training data; and encoding the current block into coded information in a bitstream based on the transform kernel.
(20). The method of feature (19), in which the current block is predicted based on one or more reference blocks that are selected from a plurality of candidate reference blocks, and the collecting includes: collecting the training data based on reconstructed residuals of the plurality of candidate reference blocks.
(21). The method of any of features (19) to (20), in which the current block is in an intra prediction mode, and the plurality of candidate reference blocks are in a same picture as the current block, the plurality of candidate reference blocks are associated with respective block vectors that are available for the intra prediction mode.
(22). The method of any of features (19) to (21), in which the current block is in an inter prediction mode, and the plurality of candidate reference blocks are in respective reference pictures of the current block, the plurality of candidate reference blocks are associated with respective motion vectors and respective reference pictures.
(23). The method of any of features (19) to (22), in which the collecting includes: performing a template matching process that determines one or more matching blocks of the current block, a template of a matching block in the one or more matching blocks satisfying a matching condition to a template of the current block; and collecting the training data according to the one or more matching blocks.
(24). The method of any of features (19) to (23), in which the collecting includes: selecting the one or more reconstructed blocks that have at least a same flag as the current block.
(25). The method of any of features (19) to (24), in which the selecting includes: selecting the one or more reconstructed blocks that have a same intra prediction mode as the current block.
(26). The method of any of features (19) to (25), in which the collecting includes: selecting the one or more reconstructed blocks that are neighboring blocks of the current block.
(27). The method of any of features (19) to (26), in which the collecting includes: filtering the one or more reconstructed blocks using a high pass filter to obtain pseudo-residuals of the one or more reconstructed blocks; and collecting the training data according to the pseudo-residuals.
(28). The method of any of features (19) to (27), in which the deriving includes: deriving the transform kernel for the current block using Karhunen Loève transform (KLT).
(29). The method of any of features (19) to (28), in which the deriving includes: deriving the transform kernel for the current block according to cost values associated with the training data by using a cost function.
(30). The method of any of features (19) to (29), in which the deriving includes: tuning one or more parameters of an initial transform kernel according to the training data to obtain the transform kernel.
(31). The method of any of features (19) to (30), in which the deriving includes: selecting the transform kernel from a plurality of transform kernel candidates according to the training data.
(32). The method of any of features (19) to (31), in which the selecting includes: selecting the transform kernel according to a transform kernel histogram that is built from the training data.
(33). The method of any of features (19) to (32), further including: encoding a flag into the bitstream, the flag indicating that the online transform kernel derivation is enabled, the flag being signaled in at least one of a transform unit level, a coding unit level, a slice level, a tile level, and a picture level.
(34). The method of any of features (19) to (33), further including: determining that the online transform kernel derivation is enabled when a counting number of the one or more reconstructed blocks that are available in the training data is larger than a threshold.
(35). The method of any of features (19) to (34), further including: determining that the online transform kernel derivation is enabled when correlations of the one or more reconstructed blocks to the current block are higher than a predefined level.
(36). The method of any of features (19) to (35), further including: determining that the online transform kernel derivation is enabled when a performance metric of the transform kernel on a template of the current block satisfies a requirement.
(37). A non-transitory computer-readable storage medium storing instructions which when executed by a processor cause the processor to perform an encoding method, the encoding method including: determining to apply an online transform kernel derivation for a current block of a current picture in a sequence of pictures in a video; collecting training data for the online transform kernel derivation for the current block based on one or more reconstructed blocks in the sequence of pictures; deriving a transform kernel for the current block based on the training data; encoding the current block into coded information in a bitstream based on the transform kernel; and transmitting the bitstream.
(38). An apparatus for video decoding, including processing circuitry that is configured to perform the method of any of features (1) to (18).
(39). An apparatus for video encoding, including processing circuitry that is configured to perform the method of any of features (19) to (36).
(40). A non-transitory computer-readable storage medium storing instructions which when executed by at least one processor cause the at least one processor to perform the method of any of features (1) to (36).

What is claimed is:

1. A method of video decoding, comprising:
receiving a bitstream comprising coded information of a sequence of pictures in a video;
collecting training data for an online transform kernel derivation for a current block based on one or more reconstructed blocks in the sequence of pictures;
deriving a transform kernel for the current block based on the training data; and
reconstructing the current block based on the transform kernel.

2. The method of claim 1, wherein the current block is predicted based on one or more reference blocks that are selected from a plurality of candidate reference blocks, and the collecting comprises:
collecting the training data based on reconstructed residuals of the plurality of candidate reference blocks.

3. The method of claim 2, wherein the current block is in an intra prediction mode, and the plurality of candidate reference blocks are in a same picture as the current block, the plurality of candidate reference blocks are associated with respective block vectors that are available for the intra prediction mode.

4. The method of claim 2, wherein the current block is in an inter prediction mode, and the plurality of candidate reference blocks are in respective reference pictures of the current block, the plurality of candidate reference blocks are associated with respective motion vectors and respective reference pictures.

5. The method of claim 1, wherein the collecting comprises:
performing a template matching process that determines one or more matching blocks of the current block, a template of a matching block in the one or more matching blocks satisfying a matching condition to a template of the current block; and
collecting the training data according to the one or more matching blocks.

6. The method of claim 1, wherein the collecting comprises:
selecting the one or more reconstructed blocks that have at least a same flag as the current block.

7. The method of claim 6, wherein the selecting comprises:
selecting the one or more reconstructed blocks that have a same intra prediction mode as the current block.

8. The method of claim 1, wherein the collecting comprises:
selecting the one or more reconstructed blocks that are neighboring blocks of the current block.

9. The method of claim 1, wherein the collecting comprises:
filtering the one or more reconstructed blocks using a high pass filter to obtain pseudo-residuals of the one or more reconstructed blocks; and
collecting the training data according to the pseudo-residuals.

10. The method of claim 1, wherein the deriving comprises:
deriving the transform kernel for the current block using Karhunen–Loève transform (KLT).

11. The method of claim 1, wherein the deriving comprises:
deriving the transform kernel for the current block according to cost values associated with the training data by using a cost function.

12. The method of claim 1, wherein the deriving comprises:
tuning parameters of an initial transform kernel according to the training data to obtain the transform kernel.

13. The method of claim 1, wherein the deriving comprises:
selecting the transform kernel from a plurality of transform kernel candidates according to the training data.

14. The method of claim 13, wherein the selecting comprises:
selecting the transform kernel according to a transform kernel histogram that is built from the training data.

15. The method of claim 1, further comprising:
decoding a flag from the bitstream, the flag indicating whether the online transform kernel derivation is enabled, the flag being signaled in at least one of a transform unit level, a coding unit level, a slice level, a tile level, and a picture level.

16. The method of claim 1, further comprising:
inferring that the online transform kernel derivation is enabled when a counting number of the one or more reconstructed blocks that are available in the training data is larger than a threshold.

17. The method of claim 1, further comprising:
inferring that the online transform kernel derivation is enabled when correlations of the one or more reconstructed blocks to the current block are higher than a predefined level.

18. The method of claim 1, further comprising:
inferring that the online transform kernel derivation is enabled when a performance metric of the transform kernel on a template of the current block satisfies a requirement.

19. A method of video encoding, comprising:
determining to apply an online transform kernel derivation for a current block of a current picture in a sequence of pictures in a video;
collecting training data for the online transform kernel derivation for the current block based on one or more reconstructed blocks in the sequence of pictures;
deriving a transform kernel for the current block based on the training data; and
encoding the current block into coded information in a bitstream based on the transform kernel.

20. A non-transitory computer-readable storage medium storing instructions which when executed by a processor cause the processor to perform an encoding method, the encoding method comprising:
determining to apply an online transform kernel derivation for a current block of a current picture in a sequence of pictures in a video;
collecting training data for the online transform kernel derivation for the current block based on one or more reconstructed blocks in the sequence of pictures;
deriving a transform kernel for the current block based on the training data;
encoding the current block into coded information in a bitstream based on the transform kernel; and
transmitting the bitstream.
